(19) United States
(12) Patent Application Publication
(10) Pub. No.: US 2021/0051965 A1
(43) Pub. Date: Feb. 25, 2021

(54) BAKED GOODS CONTAINING PREGELATINIZED WAXY CASSAVA STARCH

(71) Applicant: Corn Products Development, Inc., Westbrook, IL (US)

(72) Inventors: Rachel Bahammou, Bridgewater, NJ (US); Elena De La Pena, Bridgewater, NJ (US); Jeffrey Sullivan, Bridgewater, NJ (US); Dilek Uzunalioglu, Bridgewater, NJ (US)

(21) Appl. No.: 16/955,611

(22) PCT Filed: Dec. 28, 2019
(86) PCT No.: PCT/US2018/067903

§ 371 Date: Jun. 18, 2020

Related U.S. Application Data
(60) Provisional application No. 62/611,665, filed on Dec. 29, 2017.

(51) Int. Cl. A21D 13/043; A21D 13/066; A21D 13/80; A21D 15/02; A23L 19/10; C08B 30/14

(52) U.S. Cl. CPC A21D 13/043; A21D 13/066; C08B 30/14; A21D 15/02; A23L 19/11; A21D 13/80

(57) ABSTRACT

Disclosed herein are baked goods with improved properties that contain pregelatinized waxy cassava starch, and methods of making such baked goods. In some embodiments the baked goods comprise between 1% and 10% by weight waxy cassava starch. In embodiments the baked goods have equal or better crumb firmness than baked goods using chemically modified starches.

Disclosed herein are baked goods with improved properties that contain pregelatinized, waxy cassava starch, and methods of making such baked goods.

The art indicates that the shelf-life and freeze/thaw stability of baked goods can be improved by adding a chemically modified starch, such as, e.g., a crosslinked starch and/or etherified starch. Such chemically modified starches improve shelf-life and freeze/thaw stability as measured by the reduction in increased firmness of the baked good over time. Chemically modified starches, however, are perceived by consumers as unhealthy. So there is a need in the art for starches perceived by consumers as healthier that can replace chemically modified starches in baked goods and similarly prevent hardening of the baked good over time.

### BRIEF DESCRIPTION OF THE DRAWINGS

FIG. 1 compares the firmness after 1 week's storage and 10 weeks' storage at ambient temperatures of an illustrative embodiment of a cookie made with pregelatinized waxy cassava starch to cookies made with a pregelatinized and chemically modified waxy cassava starch, a pregelatinized waxy corn starch, and a pregelatinized and chemically modified waxy corn starch.

FIG. 2 compares the crumb firmness measured after thawing, after 1 day's storage and 1 week's storage at −18° C. of an illustrative embodiment of a thawed gluten-free bread made with pregelatinized waxy cassava starch to a thawed gluten-free bread made with a pregelatinized non-waxy cassava starch and a pregelatinized and chemically modified waxy cassava starch.

One aspect is directed to a method of making a baked good comprising mixing a pregelatinized waxy cassava starch with a second conventional bakery ingredient to form a mixture, and baking the mixture to form the baked good. Another aspect is directed to a method of making a baked good comprising mixing a pregelatinized waxy cassava starch and an unmodified flour with a second conventional bakery ingredient to form a mixture, and baking the mixture to form the baked good. Still another aspect is directed to a method of making a baked good comprising mixing a pregelatinized waxy cassava starch and a flour and/or second starch with a second conventional bakery ingredient to form a mixture, and baking the mixture to form the baked good. In one or more methods described herein, the pregelatinized waxy cassava starch is added in sufficient amount to act as an anti-staling agent. Still another aspect is directed to one or more methods in which the pregelatinized waxy cassava starch increases the moistness, freeze/thaw stability, and/or shelf-life of a baked good made with said pregelatinized waxy cassava starch compared to a baked good that is not made with a pregelatinized waxy cassava starch. Yet another aspect is directed to a method in which a baked good made with a pregelatinized waxy cassava starch is less firm after 10 weeks storage at ambient temperatures (for example between 20° and 25° C.) compared to a baked good that is not made with a waxy cassava starch. Yet still another aspect is directed to a method in which a baked good made with a pregelatinized waxy cassava starch is as firm or less firm after 10 weeks storage at ambient temperatures (for example between 20° and 25° C.) compared to a baked good made with a pregelatinized and modified waxy cassava starch. Yet a further aspect is directed to one or more methods for making a baked good with pregelatinized waxy cassava starch in which the firmness of the baked good increases by less than 100%, less than 200%, or less than 300% after 10 weeks' storage at ambient temperatures (for example between 20° and 25° C.), or wherein the increase in firmness is determined by comparing the firmness of the baked good after 1 week's storage to the firmness of the baked good after 10 weeks' storage. Yet an even further aspect is directed to one or more methods for making a baked good with pregelatinized waxy cassava starch, wherein said method produces a baked good that is less firm after being frozen and thawed than a baked good that is not made with a pregelatinized waxy cassava starch, wherein the firmness of the baked good is measured after 7 days of storage at −18° C. Yet still an even further aspect is directed to one or more methods for making a baked good with pregelatinized waxy cassava starch, wherein said method produces a baked good that is as firm or less firm after being frozen and thawed than a baked good made with a pregelatinized and modified waxy cassava starch, wherein the firmness of the baked good is measured after 7 days of storage at −18° C. An additional embodiment is directed to a baked good that is frozen and thawed to provide a thawed bake good, and wherein the thawed baked good has an increase in firmness during storage at −18° C. for 7 days of less than 100%, 90%, 80%, or 70%, or when comparing the firmness of the thawed baked good after 1 day's storage at −18° C. to the firmness of the thawed baked good after 7 day's storage at −18° C.

Another aspect is directed to a method for using pregelatinized waxy cassava starch to make a gluten-free or gluten containing baked good. Still another aspect is directed to a method for using pregelatinized waxy cassava starch to make a baked good selected from a cookie, a gluten-free cookie, a bread, a gluten-free bread, a yellow cake, and a gluten-free yellow cake. Another aspect is directed to a method for making a baked good with pregelatinized waxy cassava starch wherein the pregelatinized waxy cassava starch is pregelatinized by drum drying. Another aspect is directed to a method for making a baked good using pregelatinized waxy cassava starch in an amount of between 0.1% and 50%, 1% and 10%, or 1% and 5%, by weight, of the baked good. Another aspect is directed to a method for making a baked good from a starch mix comprising a pregelatinized waxy cassava starch and a second starch that is not a waxy cassava starch. Still another aspect is directed to a method for making a baked good from a starch mix comprising a pregelatinized waxy cassava starch and a second starch, optionally wherein the pregelatinized waxy cassava starch is used in an amount of between 0.1% and 10% of the starch mix.

Within this specification waxy cassava starch (also called tapioca starch) is a naturally low amylose starch. In embodiments the waxy cassava starch has less than 10% amylose by weight, or less than 5% amylose by weight, or less than 3% amylose by weight, or essentially 0% amylose by weight.

Pregelatinization is a term that is well known in the art. Without narrowing the full understanding of the term, in one aspect, a pregelatinized starch is a starch that is sufficiently heated in the presence of sufficient water to break down the internal structural of a starch granule. In another aspect, this break down can be measured by the destruction of the Maltese cross diffraction pattern apparent when starch is viewed under polarized light. As used in this specification, a pregelatinized starch is not otherwise modified unless specifically indicated. Additionally reference to a modified starch within this application means, for example, but not limited to chemical, enzymatic, or physical modification to a base starch. Illustrative modifications include, but are not limited to, starch conversion by oxidation, enzyme, or acid; starch stabilizing and/or crosslinking using for example, propylene oxide/phosphorous oxychloride, acetic anhydride/adipic anhydride, or STMP/STPP; thermal treatments such as thermal inhibition, or thermal annealing, or so called heat-moisture-treatments.

In one embodiment, the pregelatinized waxy cassava starch may be pregelatinized using any non-chemical means, including, but not limited to spray drying, drum drying, and extrusion. An illustrative process for pregelatinizing starch using drum drying follows. Starch slurry (30-40% solids w/w) is fed onto an applicator roller of a heated single drum (a single drum process). The slurry forms a film on the drum, and the film is removed from the drum using a blade. The film is then ground to a desire particle size. The amount of pregelatinization is affected, for example, by the solids content of the slurry, the temperature of the drum, the speed of rotation of the drum, and the cook time. Commonly, the drum is heated to temperatures between 50° and 150° C. and rotates at a rate of between 15 and 30 rpm. The starch is cooked for a period of between 15 and 30 minutes.

In some embodiments, the pregelatinized waxy cassava starch is used as the sole starch component in one or more baked goods described herein, where the amount of pregelatinized waxy cassava starch used is between 0.1% and 50%, between 10% and 40%, or between 20% and 30% of the baked good (by weight).

Another aspect is directed to a starch mix comprising pregelatinized waxy cassava starch. Yet another aspect is directed to a starch mix comprising between 0.1% and 50%, 1% and 25%, 1% and 10%, 1% and 5%, or 2% and 7.5% by weight pregelatinized waxy cassava starch. In some embodiments, one or more starch mixtures described herein comprise a pregelatinized waxy cassava starch and at least one other starch or flour, which may be unmodified, pregelatinized and/or modified. In another embodiment the at least one other starch or flour component includes but is not limited to non-waxy cassava starch (cassava starch naturally having greater than about 10% amylose, and more typically naturally having between 15% and 25% amylose by weight) as well other waxy starches (less than about 10% amylose content) or high amylose starches (greater than about 40% amylose), illustrative starch bases (whether having high, low, or standard amylose content) include, but are not limited to wheat, rice, potato, corn, oats, sago, arrowroot, pea, fava bean, lentil, and other pulses. In some embodiments, the starch mixture described herein is gluten free. In other embodiments, the starch mix described herein further comprises a non-waxy cassava starch, a rice flour, and a potato starch. In still other embodiments, the starch mix described herein comprises a wheat flour.

In yet another embodiment, one or more gluten-free baked goods (for example gluten-free breads) described herein is made from a starch mix comprising an unmodified starch and/or flour component and a pregelatinized waxy cassava starch. In another embodiment, the unmodified starch and/or flour component comprises a plurality of unmodified starch and/or flour components. In another embodiment, the unmodified starch and/or flour component comprises an unmodified cassava starch (non-waxy), an unmodified rice flour, and an unmodified potato starch. In another embodiment, the unmodified cassava starch, unmodified rice flour, and unmodified potato starch are mixed in a about a 1:1:1 ratio. In another embodiment any one of the three components may make up between 20% and 40% of the unmodified starch and/or flour component.

Another embodiment is directed to a baked good comprising a pregelatinized waxy cassava starch. A further embodiment is directed to a baked good comprising between 1% and 10% or 1% and 5% by weight pregelatinized waxy cassava starch. Yet another embodiment is directed to a baked good comprising a pregelatinized waxy cassava starch and a second conventional bakery ingredient. A further embodiment is directed to a baked good comprising between 1% and 10% or 1% and 5% by weight pregelatinized waxy cassava starch and a second conventional bakery ingredient. In still another embodiment, one or more baked goods described herein contains pregelatinized waxy cassava starch that is pregelatinized by drum drying

Still another embodiment is directed to a baked good comprising a starch mix comprising a pregelatinized waxy cassava starch. In even further embodiments, the baked good is a gluten-free or gluten containing baked good. In an even further embodiment, one or more baked good described herein is a gluten-free bread that further comprises a starch and/or flour mixture comprising a starch, wherein said starch is unmodified and is not a waxy cassava starch. In some embodiments, the one or more baked good described herein is selected from bread, pizza dough, cookies, cakes, brownies, pie crusts, and muffins. In some embodiments, the baked good is a cookie.

In other embodiments, the second conventional bakery ingredient is selected from a sweetener (including, but not limited to, e.g., sucrose, corn syrup, rebaudioside, and allulose); salt; a leavening agent (e.g. baking soda or baking powder); a flavoring agent; a hydrocolloid; an oil or shortening or other fat; an egg; water; a nut; a fruit; and a candy (e.g. chocolate chips). In some embodiments, the baked good is a yellow cake. In one embodiment, the yellow cake comprises a pregelatinized waxy cassava starch and a second conventional bakery ingredient selected from a sweetener (including, but not limited to, e.g., sucrose, corn syrup, rebaudioside, and allulose); salt; a leavening agent (e.g., baking soda or baking powder); a flavoring agent: a hydrocolloid; an oil or shortening or other fat; an egg; and water or other liquid (e.g., juice, milk, and oil). In another embodiment, the baked good is a gluten-free bread. In another embodiment, the gluten free bread comprises a pregelatinized waxy cassava starch and a second conventional bakery ingredient selected from a sweetener (including, but not limited to. e.g., sucrose, corn syrup, rebaudioside, and allulose); salt; yeast or other leavening agent; a flavoring agent; a hydrocolloid; an oil or shortening or other fat; an egg; and water.

Another embodiment is directed to a baked good comprising pregelatinized waxy cassava starch, wherein said baked good has a freeze/thaw stability that is better than the freeze/thaw stability of a baked good made with a starch that is not a waxy cassava starch. Still another embodiment is directed to a gluten free bread comprising pregelatinized waxy cassava starch, wherein said gluten-free bread has a freeze/thaw stability as good as or better than the freeze/thaw stability of a gluten-free bread comprising a pregelatinized and modified waxy cassava starch. In other embodiments, a baked good or gluten-free bread described herein that is stored for 7 days at −18° C. has a crumb firmness of between 300 g and 500 g (gram-force), 350 g and 450 g (gram-force), or 375 g and 425 g (gram-force) after being thawed at a temperature of between 20° and 25° C. In another embodiment, a baked good or gluten-free bread described herein that is stored for 1 day at −18° C. has a crumb firmness of between 100 g and 300 g (gram-force), 150 g and 250 g (gram-force), or 125 g and 225 g (gram-force) after being thawed at a temperature of between 20° and 25° C. In another embodiment, the percent increase of the crumb firmness over 7 day's storage at −18° C. of a baked good or gluten-free bread described herein is less than 100%, less than 90%, less than 80%, between 70% and 90%, or between 70% and 80%, wherein the comparative baked goods or loaves are stored for 1 day and 7 days at −18° C. and crumb firmness is measured after the baked goods or loaves are thawed at a temperature of between 20° and 25° C.

Another embodiment is directed to a baked good comprising a pregelatinized, waxy cassava starch, wherein said baked good has a shelf-life that is better than the shelf-life of a baked good (gluten-free or not gluten-free) comprising a pregelatinized non-waxy cassava starch (whether or not chemically modified). Still another embodiment is directed to a baked good (gluten-free or not gluten-free) comprising a pregelatinized waxy cassava starch, wherein said baked good has a shelf-life as good as or better than the shelf-life of a baked good comprising pregelatinized and chemically modified waxy cassava starch. Still another embodiment is directed to a cookie or cake comprising pregelatinized waxy cassava starch, wherein said cookie or cake has a shelf-life as good as or better than the shelf-life of a cookie or cake comprising a pregelatinized and chemically modified waxy cassava starch. In another embodiment, the shelf-life is assessed by measuring the firmness of the baked good over time. In some embodiments, one or more baked good or cookie described herein has a firmness between 250 g and 1500 g (gram-force), 500 g and 1000 g (gram-force), or 500 g and 900 g (gram-force) after being stored for 1 week at ambient temperatures or temperatures between 20° and 25° C. In another embodiment, one or more baked good or cookie described herein has a firmness of between 1500 g and 3000 g (gram-force), 2000 g and 2500 g (gram-force), or 2100 g and 2400 g (gram-force) after being stored for 10 weeks at ambient temperatures or temperatures between 20° and 25° C. In an even further embodiment, the percent increase in firmness of one or more cookie or baked good described herein over 10 weeks' storage is less than 400%, less than 300%, less than 200%, or between 100% and 400% and all intervals in between, wherein the comparative baked goods or cookies are stored for 1 week or 10 weeks at ambient temperatures or temperatures between 20° and 25° C., and wherein said firmness is measured at between 20° and 25° C.

In an even further embodiment, the firmness described herein is measured with a TA.XT texture analyzer using a probe advanced at a rate of 4 mm/s over a distance of 15 mm, at applied force of 20 g (g_{f}). In yet a further embodiment, the firmness is measured at least 10 times and averaged to provide the firmness.

The invention is further described by reference to the following examples, which are provided for illustrative purposes and are not limiting in any way. A person of ordinary skill in the art would understand that variations can be made to the Examples that would be within the scope of the claims.

### Procedural

Firmness measurements were made using a TA.XT texture analyzer using a probe advanced at a rate of 4 mm/s over a distance of 15 mm, at applied force of 20 g (g_{f}). Ten measurements were taken per sample.

### Example 1

### Chocolate Chip Cookies

Chocolate chip cookies were made using the recipe provided in Table 1.

TABLE 1
Cookie Recipe

| Ingredient | Usage percentage (w/w) |
|---|---|
| All-purpose flour | 30% |
| Starch from Table 2 | 2% |
| Baking soda | 0.5% |
| Salt | 0.5% |
| Butter, unsalted | 25% |
| Light brown sugar | 15% |
| Granulated sugar | 15% |
| Eggs | 11% |
| Vanilla extract | 1% |
| TOTAL | 100% |
| Chocolate chips | N/A |

Cookies were made by mixing the Table 1 ingredients together and baking at 375° F. for 8-10 minutes. The cookies were cooled and stored at ambient temperature. Cookie firmness was measured after being stored for 1 week and 10 weeks.

Cookies were prepared using the starches listed in Table 2.

TABLE 2
Starches used in Cookies

| Sample | Modification |
|---|---|
| 1 | Pregelatinized modified waxy corn starch. |
| 2 | Drum dried and modified waxy corn starch - 8.8% PO and |
| | 0.018% POCl₃ |
| 3 | Pregelatinized waxy cassava starch (drum dried, low drum |
| | speed) |
| 4 | Pregelatinized waxy cassava starch (drum dried, high speed) |
| 5 | Pregelatinized and modified waxy cassava starch - 4% PO and |
| | 0.012% POCl₃ |
| 6 | Pregelatinized and modified waxy cassava starch - 8% PO, |
| | 0.015% POCl₃ |
| 7 | Pregelatinized and modified waxy cassava starch crosslinked |
| | only - 0.58% mixed adipate |
| 8 | Pregelatinized and modified waxy cassava starch - 4% AA and |
| | 0.58% mixed adipate |
| 9 | Crosslinked, spray dried non-waxy cassava starch |

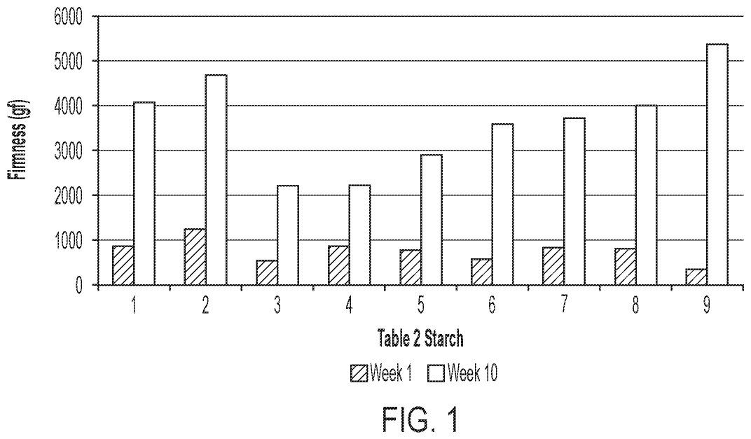

Shelf-life for cookies, as measured by crumb force is reported in FIG. 1, which shows that cookies made using pregelatinized waxy cassava starch were softer after being stored for 10 weeks than were cookies made with any of the other Table 2 starches. Notably, this effect was observed independent of the amount of drum drying as cookies made from pregelatinized waxy cassava starch subjected to low speed drum drying and high speed drum drying exhibited similar firmness to each other, and exhibited improved firmness compared to the pregelatinized and modified waxy cassava starches. It is further notable that cookies made using the pregelatinized waxy cassava starches were less firm after being stored for 10 weeks at ambient temperature than cookies made with the Table 2 pregelatinized and modified waxy cassava starches even though all cookies using waxy cassava starch were similarly firm after being stored for 1 week at ambient temperature.

### Example 2

### Gluten-Free Bread

Gluten-free bread was made using the recipe provided in Table 3.

TABLE 3
Gluten-free Bread Recipe

| | Baker's Percent | True Percent |
|---|---|---|
| Ingredients | (w/w) | (w/w) |
| Cassava starch (non-waxy) | 35 | 14.2 |
| Rice Flour | 35 | 14.2 |
| Potato starch | 30 | 12.2 |
| Pregelatinized starch from Table 4 | 5.6 | 2.3 |
| Egg White Powder | 3.6 | 1.5 |
| Salt | 1.9 | 0.8 |
| Xanthan gum | 1.9 | 0.8 |
| Canola Oil | 12 | 4.9 |
| High Fructose Corn Syrup | 4.9 | 2 |
| Water | 115 | 46.7 |
| Yeast, Instant | 1.6 | 0.6 |
| TOTAL | | 100 |

Gluten-free bread was made by mixing together corn syrup, water (77° F.) and yeast (to activate the yeast). The dry ingredients were mixed and yeast mixture was added. All ingredients were mixed to form dough. The dough was proofed for 60 to 80 minutes at 95° F. (85% relative humidity). The dough was then baked at between 400° and 425° F. for 45 minutes to produce loaves of bread that were allowed to cool. Cooled loaves were transferred to a plastic bag and frozen and stored at −18° C. The loaves were thawed after being stored for 24 hours and after being stored for 1 week and crumb firmness was measured.

Gluten-free loaves of bread were made using the starches listed in Table 4.

TABLE 4
Starches Used in Bread

| Sample | Modification |
|---|---|
| 1 | Pregelatinized waxy cassava starch (low drum speed) |
| 2 | Pregelatinized non-waxy cassava starch |
| 3 | Pregelatinized, modified waxy cassava starch (4% PO, 0.012% |
| | POCl₃,) |
| 4 | Pregelatinized, modified waxy cassava starch (8% PO, 0.015% |
| | POCl₃, high drum speed) |
| 5 | Pregelatinized, modified waxy cassava starch (8% PO, 0.015% |
| | POCl₃, low drum speed) |
| 6 | Pregelatinized, modified waxy cassava starch (4% AA, 0.58% |
| | mixed adipate, high drum speed) |
| 7 | Pregelatinized, modified waxy cassava starch (4% AA, 0.58% |
| | mixed adipate, low drum speed) |

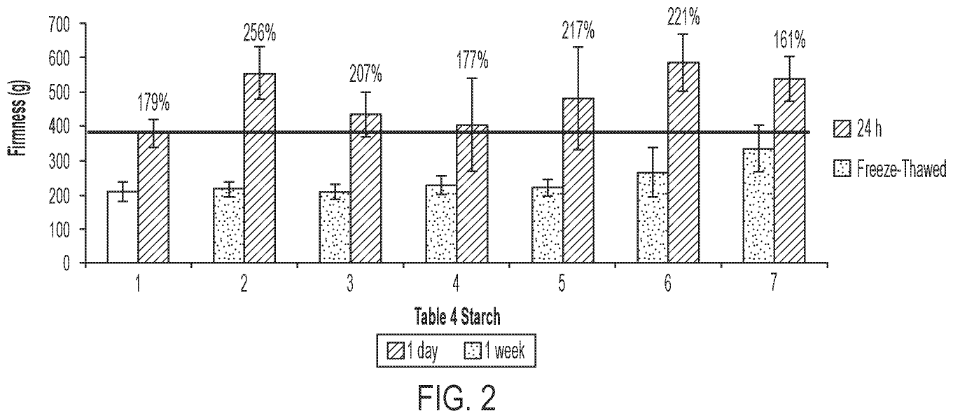

Results are shown in FIG. 2, which shows that thawed bread made with pregelatinized waxy cassava starch has a softer crumb and lower percent increase in crumb firmness when compared to a bread made with pregelatinized non-waxy cassava starch and pregelatinized and chemically modified waxy cassava starch after the bread is stored for 1 day and 7 days at −18° C.

1. A gluten free baked good comprising between 1% and 10% by weight pregelatinized but otherwise unmodified waxy cassava starch and a second gluten free starch or flour that is not a waxy cassava starch and a third conventional bakery ingredient.

2. The baked good of claim 1, wherein the gluten-free starch second starch or flour that is not a waxy cassava starch is an unmodified starch or flour.

3. The baked good of claim 1, wherein the baked good is a gluten-free bread. is selected from the group consisting of non-waxy cassava starch, rice starch or flour, potato starch, and mixtures thereof.

4. The baked good of claim 1 wherein said baked good has a crumb firmness of between 300 g and 500 g (gram-force), 350 g and 450 g (gram-force), or 375 g and 425 g (gram-force) when, baked good is stored at −18° C. for 7 days, and the crumb firmness is measured after thawing the baked good at between 20° C. and 25° C.

5. The baked good of claim 1 wherein said baked good has a percent increase of crumb firmness of between 70% and 90% after being stored for 1 or more days.

6. (canceled)

7. The baked good of claim 1, wherein said baked good has a firmness of between 2,000 g and 2,500 g (gram-force) when stored at between 20° and 25° C. for 10 weeks.

8. (canceled)

9. The baked good of claim 1 wherein said baked good is a cookie, a cake or a cookie.

10. (canceled)

11. (canceled)

12. The baked good of claim 1 wherein the pregelatinized waxy cassava starch is pregelatinized by drum drying.

13. A method of making a gluten free baked good comprising: mixing a pregelantinized but otherwise not modified waxy cassava starch a second gluten free starch or flour that is not a waxy cassava starch and a liquid third conventional bakery ingredient to form a mixture; and
baking the mixture to form the gluten free baked good.

14. The method of claim 13, wherein the pregelatinized waxy cassava starch is added to the mixture in an amount of between 1% and 10% by weight.

15. The method of claim 13, further comprising storing the baked good for 10 weeks at between 20° C. and 25° C.

16. (canceled)

17. The method of claim 13, wherein the baked good is a cookie, a bread, or a cake.

18. The method of claim 13 wherein the second gluten-free starch or flour is unmodified.

19. The method wherein the baked good is a gluten-free baked good is selected from the group consisting of non-waxy cassava starch, rice starch or flour, potato starch, and mixtures thereof.

20. The method of claim 13 further comprising freezing the bake good wherein the thawed baked good has an increase in firmness.

21. The method of claim 13, wherein the second starch or flour is selected from the group consisting of unmodified non-waxy cassava starch, unmodified rice starch or flour, unmodified potato starch, and mixtures thereof.

22. (canceled)

23. (canceled)

24. (canceled)

25. (canceled)

26. (canceled)

27. (canceled)

28. (canceled)

29. (canceled)

30. (canceled)

31. A starch mix comprising between 0.1% and 10% by weight pregelatinized but otherwise unmodified waxy cassava starch and a second gluten free starch or flour.

32. The starch mix of claim 31, wherein the second gluten free starch or flour is unmodified.

33. The starch mix of claim 31 wherein the second gluten free starch or flour is selected from the group consisting of non-waxy cassava starch, a rice starch or flour, and a potato starch and mixtures thereof.

34. The starch mix of claim 31 wherein the second starch or flour is selected from the group consisting of unmodified non-waxy cassava starch, unmodified rice starch or flour, unmodified potato starch, and mixtures thereof.
